(19) United States
(12) Patent Application Publication
(10) Pub. No.: US 2015/0215409 A1
(43) Pub. Date: Jul. 30, 2015

(54) METHOD AND APPARATUS FOR LOCATION-BASED PUBLICATIONS AND SUBSCRIPTIONS

(71) Applicants: Likhang Chow, Beijing (CN); Hao Yang, San Jose, CA (US); Zhen Liu, Tarrytown, NY (US)

(72) Inventors: Likhang Chow, Beijing (CN); Hao Yang, San Jose, CA (US); Zhen Liu, Tarrytown, NY (US)

(73) Assignee: Nokia Corporation, Espoo (FI)

(21) Appl. No.: 14/424,667

(22) PCT Filed: Sep. 4, 2012
(86) PCT No.: PCT/CN2012/080964

§ 371 Date: Feb. 27, 2015

(51) Int. Cl. H04L 29/08; H04W 4/02

(52) U.S. Cl. CPC H04L 67/18; H04W 4/021

(57) ABSTRACT

A method, apparatus, computer program product and system are provided for providing mobile services via a scalable location-based publication/subscription comprising a subscription system. In this regard, a method is provided that includes receiving at least one subscription comprising a subscription area and at least one publication comprising a publication location. The method further includes determining a geohash representation of the subscription area and determining whether the at least one publication matches the at least one subscription based at least on the publication location and the geohash representation of the representation of the subscription area. The method further includes causing content associated with the at least one publication to be transmitted in an instance in which the at least one publication matches the at least one subscription.

### TECHNOLOGICAL FIELD

An example embodiment of the present invention relates generally to techniques for managing location-based publications and subscriptions and, more particularly, to a method and apparatus for providing mobile services via a scalable location-based publication/subscription system.

### BACKGROUND

With the increasing prevalence of smart phones, service providers have seen a dramatic increase in the popularity of location based services in various application domains, such as weather, commerce, photo sharing, etc. For example, users may be interested in nearby coupons. Whenever there is a new coupon published by a merchant, the system needs to find the set of users that are interested in that coupon and are geographically nearby based on location of the user mobile devices. The system may then provide the coupon to the nearby users.

Unfortunately, existing publish/subscribe systems are mostly optimized for matching speed, and system performance may suffer severely under highly dynamic workload, e.g., as users move around and update their locations. Without the ability to quickly process location updates, it may be difficult for these existing systems to handle the increased workload brought on by the growing user base of location-based services.

### BRIEF SUMMARY

A method, apparatus and computer program product are therefore provided according to an example embodiment of the present invention for providing mobile services via a location-based publication/subscription system. In this regard, the method, apparatus, and computer program product of one embodiment may provide a location-based publication/subscription system which utilizes geohash representations and, according to a further embodiment, Manhattan distances, in order to manage location-based subscriptions and publications. In this way, the method, apparatus, and computer program may allow location-based subscriptions and publications to be managed more efficiently than in conventional systems.

In one embodiment, a method is provided that includes receiving at least one subscription that includes a subscription area and receiving at least one publication that includes a publication location. The method further includes determining a geohash representation of the subscription area and determining, based at least on the publication location and the geohash representation of the subscription area, whether the at least one publication matches the at least one subscription. The method also includes causing content associated with the at least one publication to be transmitted in an instance in which the at least one publication matches the at least one subscription.

In a further embodiment, an apparatus is provided that includes at least one processor and at least one memory including program code instructions, the at least one memory and the program code instructions being configured to, with the processor, direct the apparatus to at least receive at least one subscription that includes a subscription area and receive at least one publication that includes a publication location. The apparatus is further directed to determine a geohash representation of the subscription area and determine, based at least on the publication location and the geohash representation of the subscription area, whether the at least one publication matches the at least one subscription. The apparatus is also directed to cause content associated with the at least one publication to be transmitted in an instance in which the at least one publication matches the at least one subscription.

In an even further embodiment, a computer program product is provided that includes a non-transitory computer readable medium storing program code portions therein. The computer program code instructions are configured to, upon execution, direct an apparatus to at least receive at least one subscription that includes a subscription area and receive at least one publication that includes a publication location. The apparatus is further directed to determine a geohash representation of the subscription area and determine, based at least on the publication location and the geohash representation of the subscription area, whether the at least one publication matches the at least one subscription. The apparatus is also directed to cause content associated with the at least one publication to be transmitted in an instance in which the at least one publication matches the at least one subscription.

In a still further embodiment, an apparatus is provided that includes means for receiving at least one subscription that includes a subscription area and means for receiving at least one publication that includes a publication location. The apparatus further means for determining a geohash representation of the subscription area and means for determining, based at least on the publication location and the geohash representation of the subscription area, whether the at least one publication matches the at least one subscription. The apparatus also includes means for causing content associated with the at least one publication to be transmitted in an instance in which the at least one publication matches the at least one subscription.

In another embodiment, a system is provided that includes a subscribing device, a publishing device, and a network element. The network element comprises an apparatus that includes at least one processor and at least one memory storing program code instructions. The memory and program code instructions are configured to, with the processor, direct the network element to at least receive, from the subscribing device, at least one subscription comprising a subscription area and to receive, from the publication device, at least one publication comprising a publication location. The network element is further directed to determine a geohash representation of the subscription area and to determine, based at least on the publication location and the geohash representation of the subscription area, whether the at least one publication matches the at least one subscription. The network element is also directed to cause, in an instance in which the at least one publication matches the at least one subscription, content associated with the at least one publication to be transmitted to the subscribing device.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is an illustration of publication/subscription matching in a location-based publication/subscription system according to example embodiments of the present invention;

FIG. 2 is a schematic diagram of the operations of a location-based publication/subscription system according to example embodiments of the present invention;

FIG. 3 is an illustration of a geohash representation;

FIG. 4 is an illustration of a geohash representation of a subscription area according to example embodiments of the present invention;

FIG. 5 is an illustration of a Manhattan distance representation of a subscription area according to example embodiments of the present invention;

FIG. 6 is an illustration of an axis rotation being performed on Manhattan distance representations of multiple subscription areas according to example embodiments of the present invention;

FIG. 7 is an illustration of a geohash representation of a subscription area using Manhattan distances according to example embodiments of the present invention;

FIG. 8 is a schematic representation of a system that may support example embodiments of the present invention;

FIG. 9 is a block diagram of a user equipment that may be configured to implement example embodiments of the present invention;

FIG. 10 is a block diagram of an apparatus that may be embodied by or associated with an electronic device, and may be configured to implement example embodiments of the present invention; and

FIG. 11 is a flowchart illustrating operations performed in accordance with an embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As described below, a method, apparatus and computer program product are provided for providing mobile services via a scalable location-based publication/subscription system. Publication/subscription systems may provide a flexible content provision paradigm in contexts in which where publishers and subscribers may be decoupled, e.g., in contexts in which they may not be in direct communication. In a publication/subscription system, subscribers may register subscriptions which define, e.g., filter, future publications that they may wish to receive. A subscription (sub) may comprise a collection of predicates, such as “key, value, operator” triple. Publishers may then send publications (pubs) to the pub/sub system. Each publication may comprise a collection of attributes, such as “key, value” pair. Each new publication received by the pub/sub system will then be matched against all the registered subscriptions. A match may be determined between a publication/subscription pair, for example, if all of the predicates in the sub are satisfied by the corresponding values in the pub. That is, a particular publication may be matched with a particular subscription if every predicate triple (key, value, operator) in the particular subscription is satisfied by the corresponding (key, value) pair in a particular publication. A location-based pub/sub (LPS) system is a particular type of pub/sub system in which one or more of the predicate/attribute types may be based on a location property.

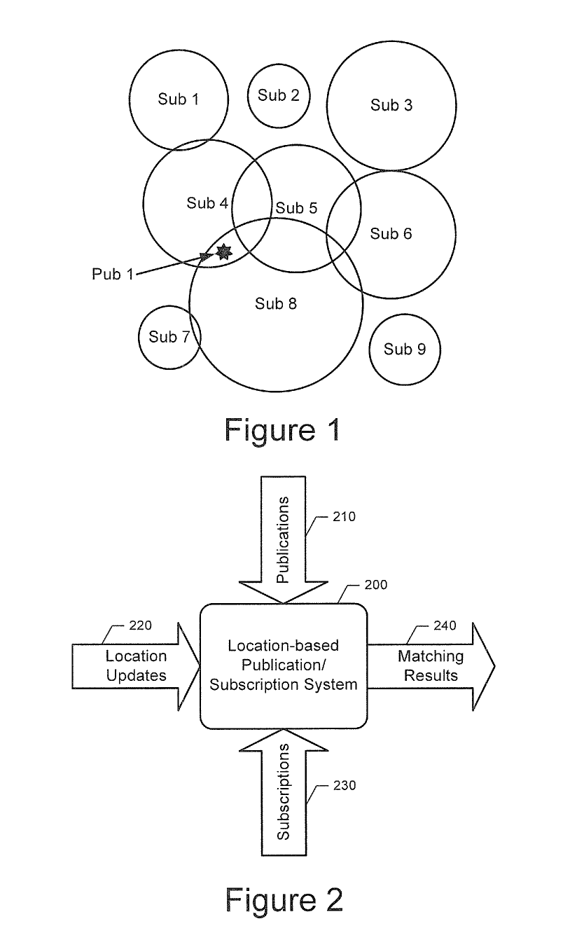

FIG. 1 illustrates the basic concept behind an LPS system. Each subscription may include a subscription area predicate which requires publications to be within a certain distance for a match to occur. Thus, as shown, each of the depicted subscriptions (e.g., “Sub 1,” “Sub 2,” etc.) may be conceptualized as a circle having a radius equal to the matching distance. Whenever there is a new publication, e.g., “Pub 1,” whose location lies within one or more subscription circle(s), the publication and the subscription(s) are matched, e.g., the location predicates are satisfied. As depicted, Pub 1 would match Sub 4 and Sub 8. A further characteristic of an LPS system is that subscriptions may be “movable.” That is, when a subscriber device associated with a particular subscription changes their location, a location update will be sent to the LPS system. These location updates may be conceptualized as causing the subscription circles depicted in FIG. 1 to move with the subscriber device. Thus, while Sub 5 is not depicted as matching Pub 1, if the user associated with Sub 5 were to move southeast by a sufficient amount, a match may be made between Pub 1 and Sub 5.

FIG. 2 illustrates at a high level the operations of an LPS system 200. As shown, the LPS system 200 may receive publications 210, subscriptions 230, and location updates 220, and return matching results 240, e.g., cause content associated with a particular publication to be provided a device associated with a corresponding matched sub. In many contexts, processing the location updates 220 may require a large percentage of the processing capabilities of the LPS system, especially when there are a large number of users, e.g., subscribers. The system burden caused by processing location updates may thus cause LPS systems to be sensitive to increases in the number of users, reducing their potential scalability. Thus, it would be desirable for an LPS system to allow for quick and efficient subscription area location updating and pub/sub matching. Accordingly, embodiments of the present invention may provide these benefits by utilizing a geohash-based scheme along with additional associated refinements and features.

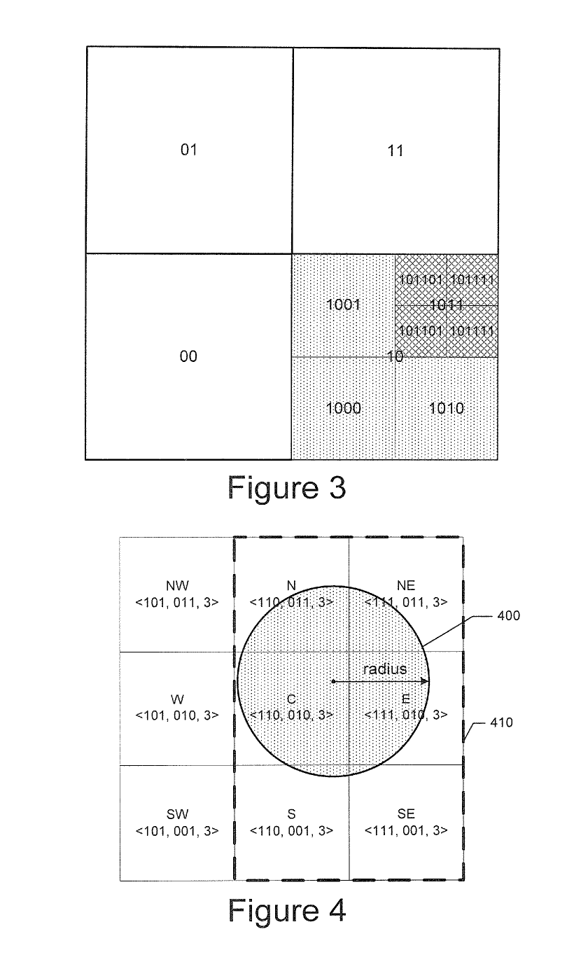

Geohash encodes the latitude/longitude co-ordinates into a human friendly string. It uses a hierarchical spatial coding scheme that subdivides space into grid-shaped cells, e.g., “geohash boxes.” By varying the length of Geohash strings, varying levels of precision can be achieved, e.g., removing tailing characters reduces precision while adding trailing characters increases precision. According to an example embodiment, a Cartesian coordinate system using integer values may be adopted, instead of floating point latitude and longitude values, to speed up computations. The location domain may also be quantized and limited according to the needs or limitations of the LPS system. For example, according to one embodiment, the location domain may be quantized and limited to a square with width 40, 030, 200 discrete units, this size being chosen based on the size of the Globe, e.g., to support a meter-level resolution. Thus, in an LPS system according to an example embodiment a geohash representation of a subscription area may be determined, such as via means discussed in detail below, by recursive divisions, starting from the entire geohash location domain. In this regard, a geohash box may be divided on x and y-dimensions at each level of division, resulting in 4 smaller geohash boxes. This division process may be repeated until a desired division level, e.g., level of precision, is reached. FIG. 3 illustrates this recursive subdivision being performed on a geohash box. The center of FIG. 3 is the origin and each box in the figure is encoded using a geohash bit-interleaving scheme (the final base-32 character encoding is omitted for the sake of clarity). Thus, it can be seen that larger boxes have shorter code length. As geohash boxes are subdivided further, e.g., as represented in the bottom right corner, the code length increases.

By using integers representations of coordinates, e.g., instead of floating point, the division (and multiplication) of the geohash boxes and their associated codes may be performed by simple bit-shifting, increasing processing efficiency. According to an example embodiment, and as shown in FIG. 4, geohash boxes may be encoded using a triple, e.g., <xBits, yBits, level>, the triple representing, for example, an x coordinate, a y coordinate, and a level of precision. According to a further example embodiment, xBits and yBits may be 32-bit integers while “level,” e.g., the level of precision, may be an 8-bit integer. So-called “buckets” may be used to store items in each geohash box. The buckets may, for example, be hash-map buckets, e.g., “geohash buckets” and, according to an even further embodiment, the efficiency of these buckets may be further improved by omitting bit interleaving and base-32 encoding, as described below. Many different methods may be used to identify a particular geohash bucket given a geohash triple. For example, a one dimensional hash value may be determined from the <xBits, yBits, level> geohash triple and used as the key in a (key,Geohashbucket) hash-map. Using this method may provide a flexible system that allows any arbitrary locations to be used. The corresponding bucket for each Geohash box may be created or destroyed on-demand dynamically. However, this approach may require extra hash-map operations, e.g., lookup, insert, and/or delete operations, in the (key,Geohashbucket) hash-map. According to an alternative embodiment, and if the area under operations, e.g., a given city, is known in advance, the geohash buckets may be pre-allocated and arranged in a three-dimensional array using the <xBits, yBits, level> triple as the key for direct access.

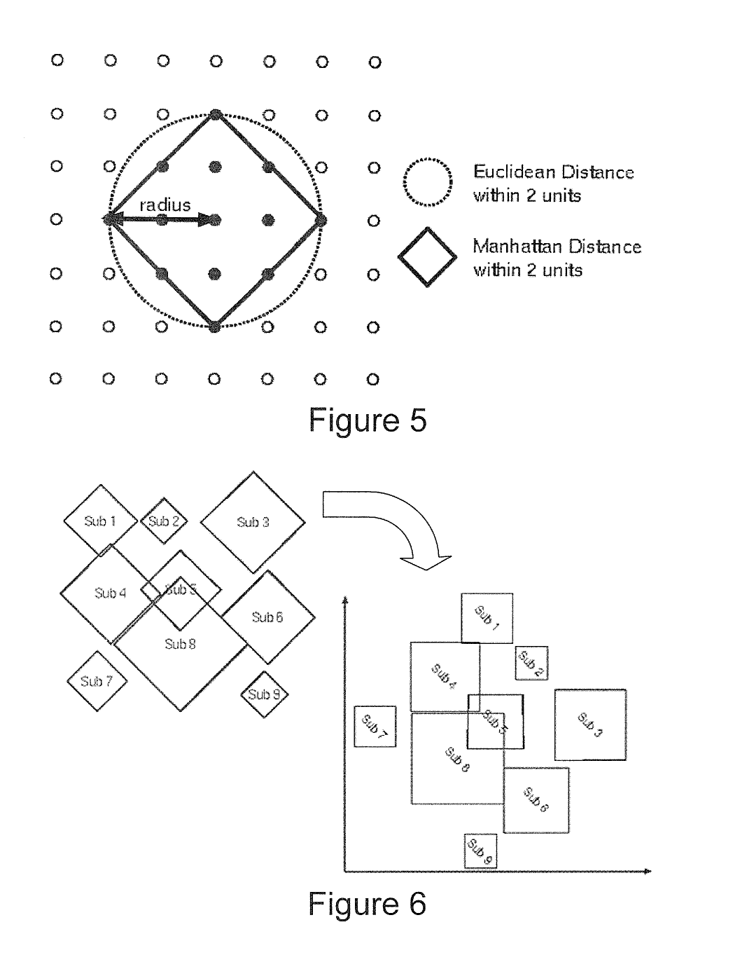

Having introduced some of the basic concepts underlying the present invention, three main operations performed by an LPS system 200 according to example embodiments, and certain refinements and additional features, will now be described with continuing reference to FIG. 4 along with FIGS. 5 and 6. For the purposes of clarity and brevity of discussion, operations and features will now be described as being carried out simply by an “LPS system.” However, it will be understood that, as will be described in further detail below, each of these operations may in actuality be performed, for example, by one or more apparatuses which may, for example, be embodied by or otherwise associated with one or more network entities, such as one or more servers, and comprising means such as one or more processors, memory devices, communication interface or the like.

Adding Subscriptions

According to example embodiments, the LPS system 200 may add a received subscription by causing a subscription identifier associated with the received subscription to be stored in one or more geohash boxes. In this regard, each subscription received by the LPS system 200 includes a subscription area which may be defined, for example, by a center and a radius. The LPS system 200 may then determine a geohash representation of the subscription area and then cause the subscription to be stored in this geohash representation of the subscription area.

In this regard, the LPS system 200 may determine the gehoash representation of such a subscription area by first determining a center geohash box which contains the subscription center and has a width just greater than the subscription radius. The center geohash box is denoted as “C” in FIG. 4. After determining the center geohash box, the LPS system 200 may next determine the eight geohash boxes surrounding the center geohash box, each of which has the potential to be overlapped by the subscription circle 400 defined by the subscription center and subscription radius. The eight surrounding geohash boxes may be determined, for example, by adding/subtracting 1 to/from the xBits and yBits of the center geohash box. For example, the geohash box directly “north” of the center box (denoted by “N”) can be found by adding one to the yBits of the center geohash box while keeping the same xBits as the center geohash box. As another example, the “NW” and “NE” boxes can be determined by subtracting/adding 1 from/to the “N” geohash box, respectively. After determining all nine “nearby” geohash boxes, the LPS system 200 may store the subscription reference (e.g., subscription identifier) in the corresponding buckets of all nine “nearby” geohash boxes.

According to further embodiments, the performance of the subscription adding operations can be improved by reducing the number of boxes in which the subscription is stored, e.g., by reducing the number of insert/remove operations on the underlying bucket hash-maps. Thus, according to an example embodiment, the LPS system 200 may carry out a merge operation after determining the nine nearby geohash boxes. In this regard, due to the hierarchical natural of geohash representations, four of the nine nearby geohash boxes, e.g., the center geohash box and three adjacent geohash boxes, may be merged into one larger geohash box with one less division level, e.g., with one less level of precision. The four geohash boxes to be merged may be selected, for example, based on the last bits in xBits and yBits of the center geohash box. For example, in FIG. 4, the N, NE, E, and C geohash boxes may be merged to a larger geohash box as they share the same prefix. The larger geohash box resulting from the merger of N, NE, E, and C would thus have <xBits, yBits, level> equal to <11, 01, 2>. Depending on the set of nine nearby geohash boxes, different sets of “corner boxes” may be merged. By performing such a merge operation, the LPS system may reduce the number of geohash boxes in the geohash representation of the subscription area from nine to six, improving the efficiency of the LPS system 200.

The geohash representation of the subscription area may be further refined by performing an “overlap check” operation. In this regard, and as shown in FIG. 4, not all of the nine nearby geohash boxes are necessarily overlapped by the subscription circle 400. Thus, the “overlap check” operation may determine which geohash boxes overlap with the subscription circle. Thus, the LPS system 200 may only store the subscription in those geohash boxes that overlap with the subscription circle 400. For example, in FIG. 4, the LPS system 200 may determine, after performing an “overlap check” operation, that the subscription need not be stored in the NW, W, and SW geohash boxes, as these geohash boxes do not overlap with the subscription circle 400. In other words, the subscription would only be stored in the N, NE, C, E, S, and SE geohash boxes, as indicated by dashed outline 410. The “overlap check” operation and the merger operation may cooperate such that the LPS system 200 may only perform a merger operation if all four of the geohash boxes to be merged pass the “overlap check,” e.g., if all four geohash boxes to be merged are overlapped by the subscription circle 400. By employing this “overlap check” operation, the LPS system 200 may not only reduce the number of geohash boxes used to store a subscription, e.g., the number of geohash boxes in the geohash representation of the subscription, but also may prevent storing a subscription in an irrelevant geohash box, which may affect lookup performance.

Updating Locations

According to example embodiments, the LPS system 200 may receive a location update for one or more subscriptions and, based on the update, cause the corresponding subscription areas to be re-located, e.g., by causing the corresponding subscription identifiers to be removed from the geohash boxes in which they were previously stored and added to new geohash boxes corresponding to the new location.

In this regard, the LPS system, upon receiving the location update, may first determine the new set of geohash boxes in which to store the corresponding subscription(s). The LPS system 200 may determine the new set of geohash boxes in a manner similar to the subscription adding process described above. Next, the LPS system 200 may determine the change in the geohash boxes based on the old set of geohash boxes assigned previously using the old location. An incremental update may then be performed. That is, geohash boxes that remain the same after the location update will be untouched. If a location update requires a subscription to be added or removed from a geohash box, the LPS system 200 need only perform an insert or delete action in the corresponding geohash box bucket. This streamlined update process may provide fast update processing and improve the scalability of the LPS system.

Pub/sub Matching

According to example embodiments, the LPS system 200 may receive a publication and determine matching subscriptions, e.g., by determining one or more subscriptions which cover a publication area associated with the received publication.

In this regard, the LPS system 200, upon receiving the publication, may first determine the subscriptions stored in the geohash box covering the publication in each division level. Depending on the application requirements, different matching modes can be performed by the LPS system, such as, for example a “rough” matching mode or an “accurate” matching mode.

Under the “rough” mode, the LPS system 200 may determine that a subscription matches a publication in an instance in which the subscription is within the same geohash box as the publication, e.g., in an instance in which a subscription identifier associated with the subscription is stored in a geohash box that the publication location falls within. Thus, in the “rough” mode, the LPS system 200 may determine that a subscription matches a publication even in instances in which the publication may not necessary fall within the subscription circle 400 of the subscription area. That is, in the “rough” mode, the LPS system 200 may return false positives. The false positives may be acceptable in the context of many mobile services, e.g., notification of nearby coupons where users are less sensitive to the location constraint. However, if a given application requires a more stringent distance constraint, e.g., zero false positives, the LPS system 200 may apply the “accurate” matching mode.

Under the “accurate” mode, the LPS system 200 may perform a distance check between the publication location and the subscription center with the subscription radius. That is, in the accurate mode, the LPS may only match subscriptions and publications if the distance between the subscription center and the publication location is less than (or, according to some embodiments, less than or equal to) the subscription radius. Under the “accurate” mode, this final distance determination may be processor intensive, especially where there are a lot of false positives. However, this downside may be mitigated, and other benefits may be realized, when the LPS system 200 employs additional enhancements such as will be described below.

Additional Enhancements to the LPS System

The performance of the LPS system may be improved even further through the use of Manhattan distances instead of conventional Euclidean distances. FIG. 5 illustrates the difference between these two distance measurements. In metropolitan settings, it may be beneficial to consider Manhattan distances (also referred to as “Taxicab distances”) due to the block-based road network design which reduces the usefulness of distances based on direct path/line of sight, e.g., Euclidean distances. Moreover, using Manhattan distances may simplify distance calculations performed by the LPS system 200. The Manhattan distance between two point p1 and p2 may be calculated as:

ManhattanDistance(p1,p2)=|xₚ₂−xₚ₁|+|yₚ₂−yₚ₁|

By using Manhattan distances instead of Euclidean distances, the LPS system may avoid more processor-intensive squaring and square root computations. As discussed above, the distance calculations required to be performed by the LPS system 200 under the “accurate” matching mode may represent a significant portion of the computation time of the matching operation. However, by using Manhattan distances, matching time may be improved.

It should be understood that, when using Manhattan distances, the subscription area will be represented as a diamond (rotated square) shape, as depicted in FIG. 5. Thus, compared to the circle using Euclidean distances, the area of the subscription area will be reduced by:

$$\frac{π {r}^{2} - {\sqrt{{r}^{2} + {r}^{2}} }^{2}}{π {r}^{2}} = 1 - \frac{2}{π} ≅ 0.36$$

The smaller area results in fewer matching results, which may inherently speed up the matching process. The results which are “filtered” out by this reduced area may not actually be meaningful to a user, e.g., a subscriber, in a metropolitan area as a direct straight path from the subscription center (user's current location) to the publication location ordinarily would not exist.

The LPS system 200 may be even further enhanced by performing an axis rotation on the subscription areas resulting from the use of Manhattan distances. In this regard, FIG. 6 illustrates a region of interest containing subscription areas defined with Manhattan distances. Note that these subscription areas (Sub 1-8) are intended to roughly correlate with those depicted in FIG. 1. To handle the diamond-shaped subscription areas defined with Manhattan distances more efficiently, the LPS system 200 may rotate the axes so that the subscription areas are converted to squares (with box width \sqrt{2r}).

Following the rotation, the resulting subscription areas fit well with the operations, e.g., the subscription adding operation, described above.

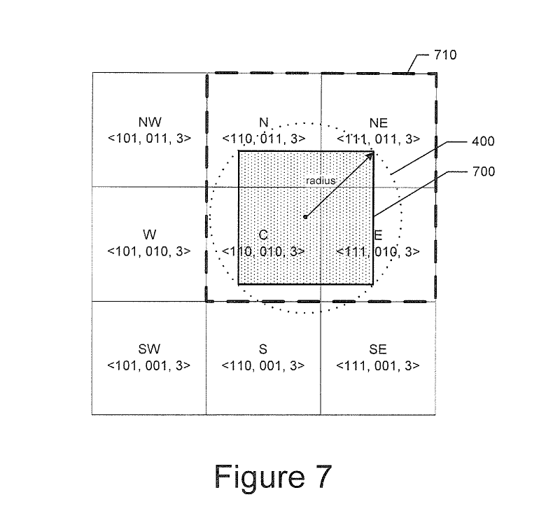

Following rotation, the LPS system 200 may follow similar steps as discussed above to process the publications and subscriptions. For example, FIG. 7 illustrates the process of determining the nine nearby geohash boxes using Manhattan distances. A dotted outline of original circular subscription area 400 is included for comparison. As can be seen in FIG. 7, the square shaped subscription area 700 as defined with Manhattan distances results in the LPS system storing the associated subscription in fewer geohash boxes when an overlap check is performed, as illustrated by dashed line 710.

It should be understood that the axis rotation process may introduce additional floating point operations. However, these additional floating point rotation operations may only be performed once for each publication or subscription and the benefits may be substantial. For example, any subsequent distance checking computations performed in the “accurate” matching may be sped up significantly. Moreover, the overlap check optimization may also be simpler when using Manhattan distances due to the lighter computations involved in square-square overlapping as compared to square-circle overlapping.

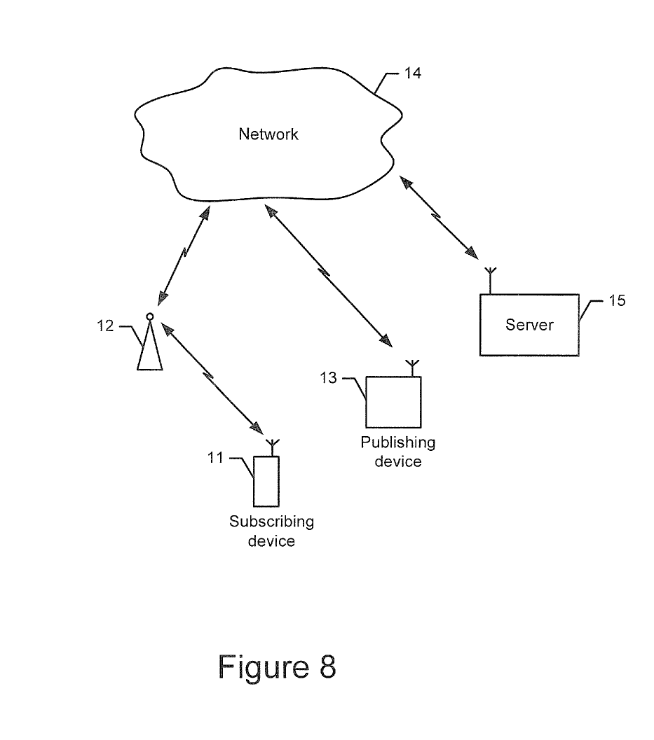

Having thus described many of the features of various embodiments of the invention generally, attention will now be turned to FIGS. 8 through 11 in order to discuss particular specific embodiments.

FIG. 8 illustrates a block diagram of a system that may benefit from embodiments of the present invention. While FIG. 8 illustrates one example of a configuration of such a system, embodiments of the present invention may be implemented in numerous other system configurations. With reference to FIG. 8, however, the system may include a subscribing device 11 connected to a common network 14, such as the internet. According to one example, the subscribing device 11 may be connected to the common network 14 via a first access point 12. The system may also include a publishing device 13 which is also connected to the common network 14, such as directly or via an intermediate device or access point (not depicted). The system may further include a network element, such as a server 15, which is also connected to the common network 14, and may store information relating to subscriptions and publications.

The subscribing device 11 and publishing device 13 may be any devices that are configured to communicate over a network. For example, the subscribing device 11 and/or publishing device 13 may be a user equipment or mobile terminal, such as a mobile telephone, PDA, pager, laptop computer, tablet computer, data card, Universal Serial Bus (USB) dongle, or any of numerous other hand held or portable communication devices, computation devices, content generation devices, content consumption devices, or combinations thereof. The publishing device 13 may also be a server, computer, or other type of fixed, e.g., non-mobile, device.

The access point 12 may be wired or wireless access points which may provide connected devices, such as subscribing device 11, access to a common network 14. For example, the access points 12 may be a base station, an access node, or any equivalent, such as a Node B, an evolved Node B (eNB), a relay node, or other type of access point. The access point 12 may also be another user equipment or mobile device serving as an access point for other devices, sharing its connection e.g. by offering tethered Internet access. The access point 12 may also be an access point configured to provide access to a local-area network, such as a WLAN. Thus, the access point 12 may be configured to operate in accordance with a WIFI standard, such as IEEE 802.11. Access points 12 and/or 13 may access the common network 14 via wired means, such as via fiber optic, coaxial, or Ethernet cable, digital subscriber line (DSL), or by connecting with a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network.

The network element 15 may be any type of network-accessible device which includes storage. For example, as depicted in FIG. 8, the network element 15 may be a server. The network element 15 may, for example, communicate with the subscribing device 11 and the publishing device 13 over one or more networks, such as the common network 14 in order to, for example, receive publications and subscriptions and provide content associated with publications subscribing devices, such as the subscribing device 11.

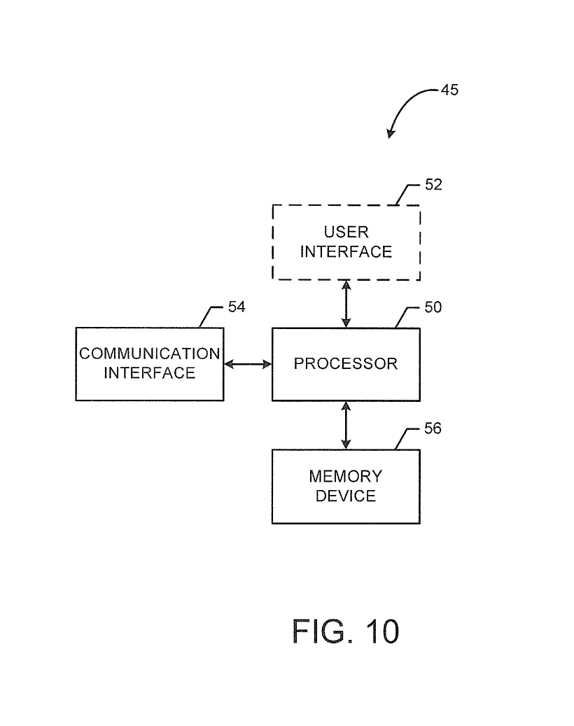

Any or all of subscribing device 11, access point 12, publishing device 13, and network element 15 may include or be associated with an apparatus 45, such as is shown in FIG. 10, configured in accordance with embodiments of the present invention, as described below.

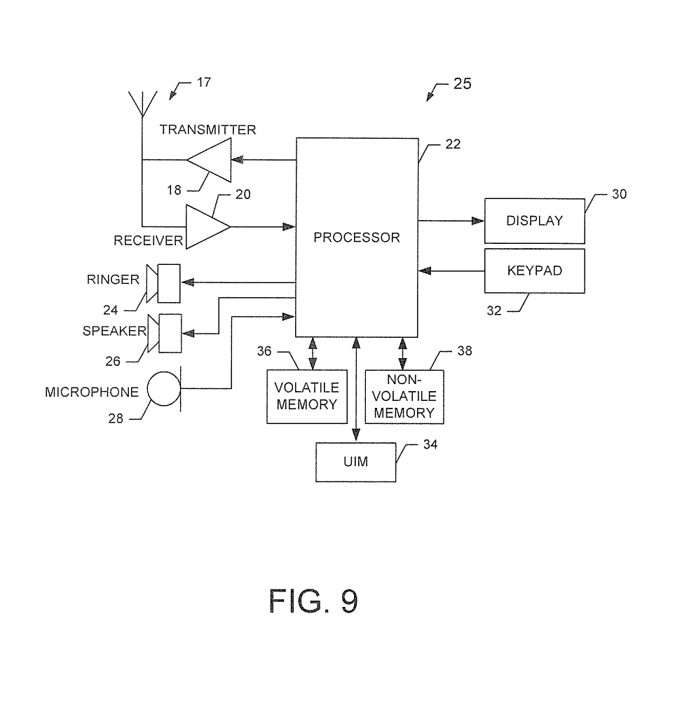

In one embodiment, subscribing device 11 and/or publishing device 13 may be embodied by a mobile terminal. In this regard, a block diagram of a mobile terminal 25 that would benefit from embodiments of the present invention is illustrated in FIG. 9. It should be understood, however, that the mobile terminal 25 as illustrated and hereinafter described is merely illustrative of one type of device that may benefit from embodiments of the present invention and, therefore, should not be taken to limit the scope of embodiments of the present invention. As such, although numerous types of mobile terminals, such as PDAs, mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, may readily employ embodiments of the present invention, other user equipment including fixed (non-mobile) electronic devices may also employ some example embodiments.

The mobile terminal 25 may include an antenna 17 (or multiple antennas) in operable communication with a transmitter 18 and a receiver 20. The mobile terminal 25 may further include an apparatus, such as a processor 22 or other processing device (e.g., processor 50 of the apparatus of FIG. 10), which controls the provision of signals to and the receipt of signals from the transmitter 18 and receiver 20, respectively. The signals may include signaling information in accordance with the air interface standard of the applicable cellular system, and also user speech, received data and/or user generated data. In this regard, the mobile terminal 25 is capable of operating with one or more air interface standards, communication protocols, modulation types, and access types. By way of illustration, the mobile terminal 25 is capable of operating in accordance with wireless communication mechanisms and may be able to communicate via multiple radio access technologies (RATs). For example, mobile terminal 25 may be capable of operating in accordance with any of a number of first, second, third and/or fourth-generation cellular communication protocols or the like. For example, the mobile terminal 25 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 25 may be capable of communicating in a wireless local area network (WLAN) or other communication networks, for example in accordance with one or more of the IEEE 802.11 family of standards, such as 802.11a, b, g, or n.

In some embodiments, the processor 22 may include circuitry desirable for implementing audio and logic functions of the mobile terminal 25. For example, the processor 22 may be comprised of a digital signal processor device, a microprocessor device, and various analog to digital converters, digital to analog converters, and other support circuits. Control and signal processing functions of the mobile terminal 25 are allocated between these devices according to their respective capabilities. The processor 22 thus may also include the functionality to convolutionally encode and interleave message and data prior to modulation and transmission. The processor 22 may additionally include an internal voice coder, and may include an internal data modem. Further, the processor 22 may include functionality to operate one or more software programs, which may be stored in memory. For example, the processor 22 may be capable of operating a connectivity program, such as a conventional Web browser. The connectivity program may then allow the mobile terminal 25 to transmit and receive Web content, such as location-based content and/or other web page content, according to a Wireless Application Protocol (WAP), Hypertext Transfer Protocol (HTTP) and/or the like, for example. Access to various software programs and provision of system services may, for example, be handled by an operating system (OS) implemented as program instructions stored in memory, such as memory 36 or 38, and executable by a processor, such as processor 22.

The mobile terminal 25 may also comprise a user interface including an output device such as a conventional earphone or speaker 26, a ringer 24, a microphone 28, a display 30, and a user input interface, all of which are coupled to the processor 22. The user input interface, which allows the mobile terminal 25 to receive data, may include any of a number of devices allowing the mobile terminal 25 to receive data, such as a keypad 32, a touch screen display (display 30 providing an example of such a touch screen display) or other input device. In embodiments including the keypad 32, the keypad 32 may include the conventional numeric (0-9) and related keys (#, *), and other hard and soft keys used for operating the mobile terminal 25. Alternatively or additionally, the keypad 32 may include a conventional QWERTY keypad arrangement. The keypad 32 may also include various soft keys with associated functions. In addition, or alternatively, the mobile terminal 25 may include an interface device such as a joystick or other user input interface. Some embodiments employing a touch screen display, as described further below, may omit the keypad 32 and any or all of the speaker 26, ringer 24, and microphone 28 entirely. The mobile terminal 25 further includes a battery, such as a vibrating battery pack, for powering various circuits that are required to operate the mobile terminal 25, as well as optionally providing mechanical vibration as a detectable output.

The mobile terminal 25 may further include a user identity module (UIM) 34. The UIM 34 is typically a memory device having a processor built in. The UIM 34 may include, for example, a subscriber identity module (SIM), a universal integrated circuit card (UICC), a universal subscriber identity module (USIM), a removable user identity module (R-UIM), etc. The UIM 34 typically stores information elements related to a mobile subscriber. In addition to the UIM 34, the mobile terminal 25 may be equipped with memory. For example, the mobile terminal 25 may include volatile memory 36, such as volatile Random Access Memory (RAM) including a cache area for the temporary storage of data. The mobile terminal 15 may also include other non-volatile memory 38, which may be embedded and/or may be removable. The memories may store any of a number of pieces of information, and data, used by the mobile terminal 15 to implement the functions of the mobile terminal 25.

Example embodiments of the invention will now be described with reference to FIG. 10, in which certain elements of an apparatus 45 for implementing an LPS system according to the example embodiments previously discussed are depicted. In order to implement the previously-described LPS system, the apparatus 45 of FIG. 10 may be employed, for example, in conjunction with the network element, such as the server 15 of FIG. 8. According to other example embodiments, however, apparatus 45 of FIG. 10 may additionally or alternatively be employed, for example, in conjunction with the subscribing device 11, the publishing device 13, and/or the access point 12. Thus, functionality of apparatus 45 discussed below may, according to some embodiments, be carried out in one of the aforementioned devices. However, according to other embodiments, the functionality of apparatus 45 discussed below may be distributed across multiple devices, each comprising a respective apparatus 45.

It should also be noted that while FIG. 10 illustrates one example of a configuration of an apparatus 45 for implementing the previously-described LPS system, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 10, the apparatus 45 for implementing an LPS system according to example embodiments of the present invention may include or otherwise be in communication with a processor 50, a communication interface 54, and a memory device 56. As described below and as indicated by the dashed lines in FIG. 10, the apparatus 45 may also optionally include a user interface 52 in some embodiments, such as embodiments in which the apparatus 45 is embodied by the subscription device 11 or the publication device 13. In some embodiments, the processor 50 (and/or co-processors or any other processing circuitry assisting or otherwise associated with the processor 50) may be in communication with the memory device 56 via a bus for passing information among components of the apparatus 45. The memory device 56 may include, for example, one or more volatile and/or non-volatile memories. In other words, for example, the memory device 56 may be an electronic storage device (e.g., a computer readable storage medium) comprising gates configured to store data (e.g., bits) that may be retrievable by a machine (e.g., a computing device like the processor 50). In the embodiment in which the apparatus 45 is embodied as a mobile terminal 25, the memory device 56 may be embodied by the memory 36, 38. The memory device 56 may be configured to store information, data, content, applications, instructions, or the like, for enabling the apparatus to carry out various functions in accordance with an example embodiment of the present invention. For example, the memory device 56 could be configured to buffer input data for processing by the processor 50. Additionally or alternatively, the memory device 56 could be configured to store instructions for execution by the processor 50.

The apparatus 45 may, in some embodiments, be embodied by or associated with a user terminal (e.g., mobile terminal 25) or a fixed communication device (e.g., the network element 15 or the access point 12) or computing device configured to employ an example embodiment of the present invention. However, in some embodiments, the apparatus 45 may be embodied as a chip or chip set. In other words, the apparatus 45 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 45 may therefore, in some cases, be configured to implement an embodiment of the present invention on a single chip or as a single “system on a chip.” As such, in some cases, a chip or chipset may constitute means for performing one or more operations for providing the functionalities described herein.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include one or more processors configured in tandem via the bus to enable independent execution of instructions, pipelining and/or multithreading. In the embodiment in which the apparatus 45 is embodied as a mobile terminal 25, the processor 50 may be embodied by the processor 22.

In an example embodiment, the processor 50 may be configured to execute instructions stored in the memory device 56 or otherwise accessible to the processor 50. Alternatively or additionally, the processor 50 may be configured to execute hard coded functionality. As such, whether configured by hardware or software methods, or by a combination thereof, the processor 50 may represent an entity (e.g., physically embodied in circuitry) capable of performing operations according to an embodiment of the present invention while configured accordingly. Thus, for example, when the processor 50 is embodied as an ASIC, FPGA or the like, the processor 50 may be specifically configured hardware for conducting the operations described herein. Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (e.g., a mobile terminal or network entity) configured to employ an embodiment of the present invention by further configuration of the processor 50 by instructions for performing the algorithms and/or operations described herein. The processor 50 may include, among other things, a clock, an arithmetic logic unit (ALU) and logic gates configured to support operation of the processor 50.

Meanwhile, the communication interface 54 may be any means such as a device or circuitry embodied in either hardware or a combination of hardware and software that is configured to receive and/or transmit data from/to a network, such as network 14, and/or any other device or module in communication with the apparatus 45. In this regard, the communication interface 54 may include, for example, an antenna (or multiple antennas) and supporting hardware and/or software for enabling communications with a wireless communication network. Additionally or alternatively, the communication interface 54 may include the circuitry for interacting with the antenna(s) to cause transmission of signals via the antenna(s) or to handle receipt of signals received via the antenna(s). In some environments, the communication interface 54 may alternatively or also support wired communication. As such, for example, the communication interface 54 may include a communication modem and/or other hardware/software for supporting communication via cable, digital subscriber line (DSL), universal serial bus (USB) or other mechanisms. In the embodiment in which the apparatus 45 is embodied as a mobile terminal 25, the communication interface 54 may be embodied by the antenna 16, transmitter 18, receiver 20 or the like.

In some embodiments, such as instances in which the apparatus 45 is embodied by the subscribing device 11 or the publishing device 13, the apparatus 45 may include a user interface 52 that may, in turn, be in communication with the processor 50 to receive an indication of a user input and/or to cause provision of an audible, visual, mechanical or other output to the user. As such, the user interface 52 may include, for example, a keyboard, a mouse, a joystick, a display, a touch screen(s), touch areas, soft keys, a microphone, a speaker, or other input/output mechanisms. Alternatively or additionally, the processor 50 may comprise user interface circuitry configured to control at least some functions of one or more user interface elements such as, for example, a speaker, ringer, microphone, display, and/or the like. The processor 50 and/or user interface circuitry comprising the processor 50 may be configured to control one or more functions of one or more user interface elements through computer program instructions (e.g., software and/or firmware) stored on a memory accessible to the processor 50 (e.g., memory device 56, and/or the like). In other embodiments, however, such as in instances in which the apparatus 45 is embodied by access point 12, access point 13, or network element 15, the apparatus 45 may not include a user interface 52.

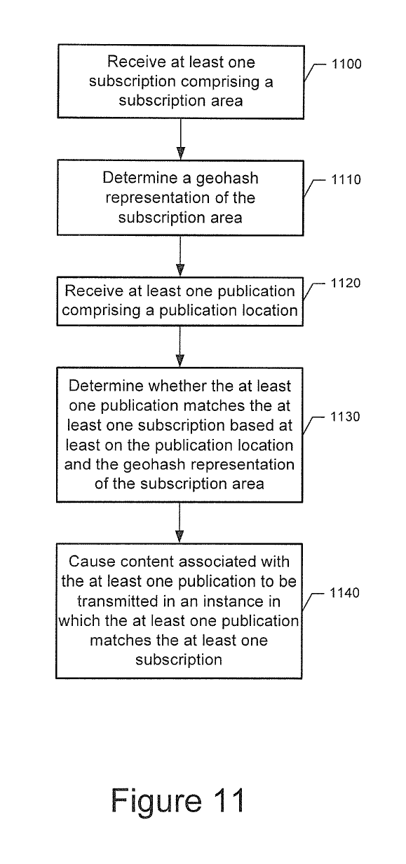

Referring now to FIG. 11, operations for providing the previously-discussed LPS system are depicted. In this regard and as described below, the operations of

FIG. 11 may be performed by an apparatus 45, such as shown in FIG. 10, embodied by or otherwise associated, for example, with the network element 15. In this regard, the apparatus 45 may include means, such as the processor 50, the memory 56, the communication interface 54 or the like, for receiving at least one subscription comprising a subscription area. See operation 1100. The subscription may be received, for example, from a device associated with the subscription, such as the subscribing device 11. As discussed above, the subscription area may, for example, include a subscription center and a subscription radius. Also as discussed above, the apparatus 45 may further include means, such as those just mentioned, for determining a Manhattan distance representation of the subscription area. Determining the Manhattan distance representation of the subscription area may, for example, include causing the Manhattan distance representation of the subscription area to be rotated with respect to an axis, as discussed above.

The apparatus 45 may also include means, such as the processor 50, the memory 56, the communication interface 54 or the like, for determining a geohash representation of the subscription area. See operation 1110. As discussed above, determining a geohash representation of the subscription area may, for example, include determining the nine geohash boxes near the subscription center, e.g., determining a center geohash box containing the subscription center and the eight surrounding geohash boxes. Determining the geohash representation of the subscription area may also include performing the merging and/or overlap checking operations detailed above. The apparatus 45 may determine the geohash representation of the Manhattan distance representation of the subscription area or the original, e.g., Euclidean distance representation, subscription area. Apparatus 45 may further include means, such as those discussed above, for causing the at least one subscription, e.g., at least one subscription indicator, to be stored in geohash boxes, e.g., geohash buckets, corresponding to the geohash representation.

The apparatus 45 may also include means, such as the processor 50, the memory 56, the communication interface 54 or the like, for receiving at least one publication comprising a publication location. See operation 1120.

The apparatus 45 may also include means, such as the processor 50, the memory 56, the communication interface 54 or the like for determining whether the at least one publication matches the at least one subscription based at least on the publication location and the geohash representation of the subscription area. See operation 1130. As discussed above, determining whether the at least one publication matches the at least one subscription may comprise determining whether the at least one publication location lies within a geohash box containing the at least one subscription, e.g., whether the at least one publication location lies within a geohash box in which at least one subscription identifier associated with the at least one subscription is stored. Also as described above, apparatus 45 may perform this matching operation as either “rough” or “accurate.” That is, apparatus 45 may determine only whether the publication location shares a geohash box with the subscription, e.g., subscription identifier, (“rough”) or, additionally, may perform a distance check (“accurate”). The apparatus 45 may perform the distance check, for example, by determining whether the distance between the subscription center and the publication center is less than (or, according to another embodiment, less than or equal to) the subscription radius. As discussed above, the apparatus 45 may use the Manhattan distance representation of the subscription area to perform these determinations.

The apparatus 45 may also include means, such as the processor 50, the memory 56, the communication interface 54 or the like for causing content associated with the at least one publication to be transmitted in an instance in which the at least one publication matches the at least one subscription. See operation 1140. The apparatus 45 may, for example, cause the content associated with the publication to be transmitted to the subscribing device 11.

As described above, FIG. 10 illustrates a flowchart of an apparatus 45, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 56 of an apparatus 45 employing an embodiment of the present invention and executed by a processor 50 of the apparatus 45. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-31. (canceled)

32. A method comprising:
receiving at least one subscription comprising a subscription area;
determining a geohash representation of the subscription area;
receiving at least one publication comprising a publication location;
determining, based at least on the publication location and the geohash representation of the subscription area, whether the at least one publication matches the at least one subscription; and
causing, in an instance in which the at least one publication matches the at least one subscription, content associated with the at least one publication to be transmitted.

33. The method of claim 32, wherein determining the geohash representation of each subscription area comprises:
determining a center geohash box which contains a center of the subscription area and comprises a width greater than a radius of the subscription area, and
determining eight surrounding geohash boxes.

34. The method of claim 32, wherein determining the geohash representation of each subscription area comprises, or further comprises, determining four or more geohash boxes which are overlapped by the subscription area.

35. The method of claim 33, wherein each geohash box comprises a divisional level, and further wherein determining the geohash representation of each subscription area further comprises merging four of the geohash boxes into one larger geohash box, the divisional level of the larger geohash box being one less than the divisional levels of the four or more merged geohash boxes.

36. The method of claim 32, further comprising receiving one or more updated subscription areas and determining a geohash representation of each updated subscription area.

37. The method of claim 32, wherein each respective subscription area comprises a center and a radius, the radius being expressed as a Manhattan distance.

38. The method of claim 37, further comprising causing each respective subscription area to be rotated with respect to an axis.

39. The method of claim 32, wherein determining whether one or more of the publications overlaps with a particular subscription comprises determining whether one or more of the publications is located within the geohash representation of the particular subscription.

40. The method of claim 32, wherein determining whether one or more of the publications overlaps with a particular subscription comprises or further comprises determining whether a distance between the publication location and a center of the subscription area is less than a radius of the subscription area.

41. An apparatus comprising at least one processor and at least one memory storing program code instructions, the memory and program code instructions being configured to, with the processor, direct the apparatus to at least:
receive at least one subscription comprising a subscription area;
determine a geohash representation of the subscription area;
receive at least one publication comprising a publication location;
determine, based at least on the publication location and the geohash representation of the subscription area, whether the at least one publication matches the at least one subscription; and
cause, in an instance in which the at least one publication matches the at least one subscription, content associated with the at least one publication to be transmitted.

42. The apparatus of claim 41, wherein determining the geohash representation of each subscription area comprises:
determine a center geohash box which contains a center of the subscription area and comprises a width greater than a radius of the subscription area, and
determine eight surrounding geohash boxes.

43. The apparatus of claim 41, wherein determining the geohash representation of each subscription area comprises: determine four or more geohash boxes which are overlapped by the subscription area.

44. The apparatus of claim 42, wherein each geohash box comprises a divisional level, and further wherein the apparatus is further directed to determine the geohash representation of each subscription area by merging four of the geohash boxes into one larger geohash box, the divisional level of the larger geohash box being one less than the divisional levels of the four or more merged geohash boxes.

45. The apparatus of claim 41, wherein the apparatus is further directed to receive one or more updated subscription areas and determine a geohash representation of each updated subscription area.

46. The apparatus of claim 41, wherein each respective subscription area comprises a center and a radius, the radius being expressed as a Manhattan distance.

47. The apparatus of claim 47, wherein the apparatus is further directed to cause each respective subscription area to be rotated with respect to an axis.

48. The apparatus of claim 41, wherein determining whether one or more of the publications overlaps with a particular subscription comprises: determine whether one or more of the publications is located within the geohash representation of the particular subscription.

49. The apparatus of claim 41, wherein determining whether one or more of the publications overlaps with a particular subscription comprises: determine whether a distance between the publication location and a center of the subscription area is less than a radius of the subscription area.

50. The apparatus of claim 41, wherein the apparatus is directed to cause the content associated with the at least one publication to be transmitted by causing the content associated with the at least one publication to be transmitted to a device associated with the at least one subscription.

51. A computer program product comprising a computer readable non-transitory storage medium emboding program code portions therein, the program code portions being configured to, upon execution, direct an apparatus to at least:
receive at least one subscription comprising a subscription area;
determine a geohash representation of the subscription area;
receive at least one publication comprising a publication location;
determine, based at least on the publication location and the geohash representation of the subscription area, whether the at least one publication matches the at least one subscription; and
cause, in an instance in which the at least one publication matches the at least one subscription, content associated with the at least one publication to be transmitted.
